(19) United States
(12) Patent Application Publication
(10) Pub. No.: US 2004/0044733 A1
(43) Pub. Date: Mar. 4, 2004

(54) Production operation management system

(76) Inventor: Huei-Chen Fan, Taipei (TW)

Correspondence Address: BACON & THOMAS, PLLC, 625 SLATERS LANE, FOURTH FLOOR, ALEXANDRIA, VA, 22314

(21) Appl. No.: 10/229,021

(22) Filed: Aug. 28, 2002

(51) Int. Cl. G06F 15/16; G06F 15/173

(52) U.S. Cl. 709/205

(57) ABSTRACT

The invention is to provide a production operation management system, including a server, at least one assembly line each having a plurality of computers at a workstation and a network for interconnecting the server and the assembly line, to perform the steps of sending a plurality of operation procedures stored in a production management software installed in the server to the computers via the network; instructing the computers to fetch a SOPs (Standard Operation Procedures) compatible multimedia data contained in the operation procedure as received; and outputting the fetched multimedia data to a visual display device or an audio device for prompting and instructing assemblers at an assembly line to finish assigned work within a specified time.

### FIELD OF THE INVENTION

The present invention relates to production management systems and more particularly to a production operation management system with improved characteristics.

### BACKGROUND OF THE INVENTION

For coping the fast changing 21st century businesses are eagerly to improve its business management for fully satisfying the needs of customers, keeping up with the market, and obtaining a good reputation among the customers. ISO (International Organization for Standardization) has promulgated a number of documents (e.g., ISO 9000 series) about quality management and quality warranty standards. Thereafter, many businesses have adopted such standards for increasing production or improving service quality. Hence, ISO 9000 issued quality management system certificates are regarded as the most important means for developing markets and obtaining a good reputation among the customers.

In general, a work mode is related to factors of men, machines, materials, techniques and environment in any business. Hence, a reduction of undesired variations of the above factors can assure a reliable production and service quality which are pursued by all businesses. In the ISO series standards, for reducing the undesired variations of the factors it is required to write a WI (Work Instruction), provide a suitable working environment, monitor and control process parameters and product features, stipulate manufacturing rules, perform equipment repair and maintenance, increase certifications about processes and equipment (if necessary), deploy qualified technician to perform manufacturing processes wherein an effect thereof is not possible of being examined, and monitoring the process parameters for assuring a reliable production and service quality. Thus, it is very popular worldwide among businesses to obtain ISO certifications for their products or services.

In WI, all SOPs (Standard Operation Procedures) are stipulated. An assembler at an assembly line can follow the SOP in the WI in performing a job. The SOP depicts an analysis on working hours, a setting of manufacturing and working rules, and a scheduling all related to engineering management support operations. Contents of the SOP are obtained from technical manuals, quality requirements, manufacturing flows, equipment operating manuals, experiences about how to solve quality defects, and teachings of technicians having long experience.

Since the assembler follows the WI in doing a job, many advantages such as higher production speed, higher quality, shorter delivery time, lower labor and working hours, reduced material waste, and improved earning are obtained. In view of this, among the ISO series standards the WI plays a very important role in increasing a reliability of production and service quality.

In general, for a business a lot of time and money are spent on producing an original WI. Further, a subsequent maintenance is also difficult. This is particularly true for many operation procedures of highly similarity. As such, many engineers responsible for producing WI may be bothered by how to maintain the WI or how to efficiently adjust the operation procedures of WI. To the worse, they even reject it.

Many engineers responsible for producing WI like to use a software package such as Word, Excel, or the like for doing the same. However, they hardly think about versions, problem about real time, reasonableness, and repeatability of the operation. A number of problems related to management of the WI have been discussed as follows:

1. Most operation procedures of an old type of machine are repeated on a newly developed type of machine. Thus, in producing a WI for the new type of machine typically an engineer copies a stored electronic file of the old version of WI. Then a partial modification is performed. Finally, a new WI is finished. In other words, this is a repeated operation.

2. The engineer has to search files of various WIs for modification once the product design is changed. It is known that a capacity of hard disk may be up to Giga bytes. Such capacity may still grow in the near future. Also, many software packages and associated files are typically stored in the high-capacity hard disk. As such, file searching in the hard disk is a difficult task. This is still true even a folder classification technique is employed for searching. In other words, an in-time consideration is not performed.

3. Sometimes a second language version of WI is required for a multi-national business. Such second language version of WI is available for branches located in countries of different languages. As such, a translation of the newly issued WI is required. This is a time consuming job. Further, it is inefficient. That is, a version consideration is not performed.

In the case of producing WI by means of a software package such as Word, typically an engineer may use functions such as cut and paste for altering an operation procedure. In a case that a batch number should be noted the corresponding batch number must be written on the WI. Once the batch number is written on the WI in case of a change of design the contents of the WI must revised correspondingly. That is, the corresponding operation procedure must be modified. Hence, an efficiency is low in producing and modifying the conventional WI. To the worse, it is prone to err.

In addition, conventionally a WI is regarded as a document in programming manufacturing processes. In the WI, details such as manufacturing steps, components, and associated specifications such as torque, appearance examination standard, test, etc are clearly specified.

However, there are rules typically adopted by an assembly line. Hence, assemblers do not always follow the SOP of WI in production. Particularly, in a complex manual manufacturing process where the same series products are manufactured on a number of similar machines. Further, the yield in a workstation may be low if such manufacturing is done totally by human memory rather than a following of WI. At this time, the only best technique for increasing yield is by strictly demanding assemblers to follow the WI.

Moreover, many businesses take standard of working hours as a tool for evaluating a performance of the assembly line. However, product quality and flexibility may be ignored by a manufacturing department while pursuing a highly efficient production. To the worse, many required manufacturing processes and testing are not performed by some manufacturing departments for obtaining such high efficiency. This is not desirable. Thus, a desired solution for a business is a consideration of all Q, C, D and F.

In fact, a stipulation of standard of working hours is intended to effectively manage the production system. Also, quality is not ignored while pursuing a possible lowest cost and highest flexibility. Such considerations cannot be ignored.

A standard as defined by the standard of working hours means a quantified description method for collectively depicting a difficulty degree of operation by a business. This is not a mathematical equation for expressing working hours of a specified assembler at the assembly line. Hence, such standard will not vary as applied to different assemblers or environments. As such, as long as there is a consensus within the business that such method for stipulating or calculating working hours is regarded as a standard.

As to applications of the standard of working hours, it is not only available for production evaluation but also served as a reference data for equipment investment or even as an index for product development. Hence, it is important for flexibly arranging suitable working hours and maintaining a good product quality.

As stated above, it is essential for a business to instruct its employees to truly use a WI for obtaining a required quality in the manufacturing processes, efficiently produce or modify the WI, effectively manage the WI, flexibly arrange standard of working hours for continuously utilizing the same, and efficiently produce or modify the WI due to time or improvement of product rather than take the WI as a means for applying for ISO certification.

### SUMMARY OF THE INVENTION

It is therefore an object of the present invention to provide a production operation management system in order to overcome the above drawbacks of the prior art such as impossible of efficiently producing or modifying the WI, effectively managing the WI and flexibly arranging standard of working hours, and truly using the WI by assemblers at the assembly line. The system includes a server, at least one assembly line each having a plurality of computers at a workstation, and a network for interconnecting the server and the at least one assembly line. The server includes a production management software having an embedded management database including a plurality of SOPs and multimedia data associated with the SOPs. In response to a reading of the software by the server the system performs the steps of sending a plurality of operation procedures in the management database to the computers via the network; instructing the computers to fetch a compatible multimedia data contained in the operation procedure as received by the computers; and sending the fetched multimedia data to a visual display device or an audio device for output. By utilizing this system, it is possible of prompting and instructing assemblers at an assembly line to finish assigned work within a specified time by complying to the SOPs of the WI.

The above and other objects, features and advantages of the present invention will become apparent from the following detailed description taken with the accompanying drawings.

### BRIEF DESCRIPTION OF THE DRAWINGS

FIG. 1 presents schematically the connection of server and workstations according to a preferred configuration of the invention;

FIG. 2 presents schematically the connection of server and workstations according to another configuration of the invention;

FIG. 3 presents a schematic structure of a management database according to a preferred embodiment of the invention;

FIG. 4 show an instruction screen according to the invention; and

FIG. 5 shows a WI screen according to the invention.

### DETAILED DESCRIPTION OF THE PREFERRED EMBODIMENTS

Recently, more customers pay attention to product quality due to the high rise of consumer consciousness. In response, for expanding business and obtaining a good reputation among the customers businesses are eagerly to obtain ISO series certifications which are regarded as an index of quality insurance. Moreover, more big businesses follow the ISO series standards. For assuring a reliable quality, such businesses gradually require their associated factories to follow the ISO standards in procuring raw materials. For coping the competition from big businesses and competitive export markets, almost all businesses eagerly introduce ISO series standards in manufacturing.

Thus, the invention is directed to a production operation management system for effectively utilizing WI at an assembly line to comply with the ISO series standards and maintaining a good quality of the products manufactured by the assembly line.

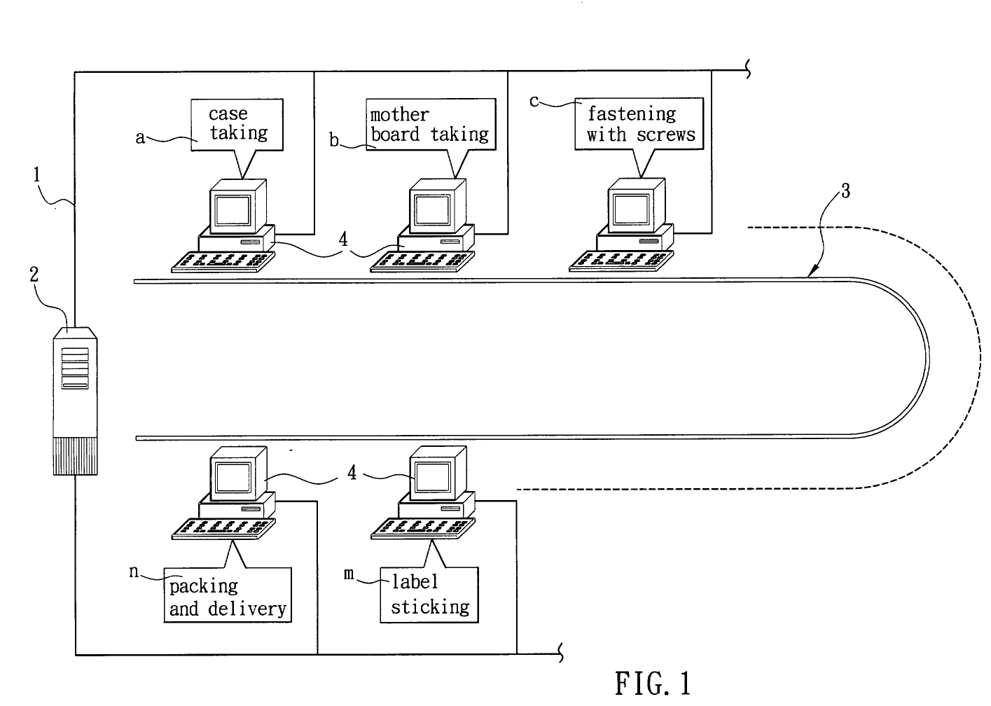

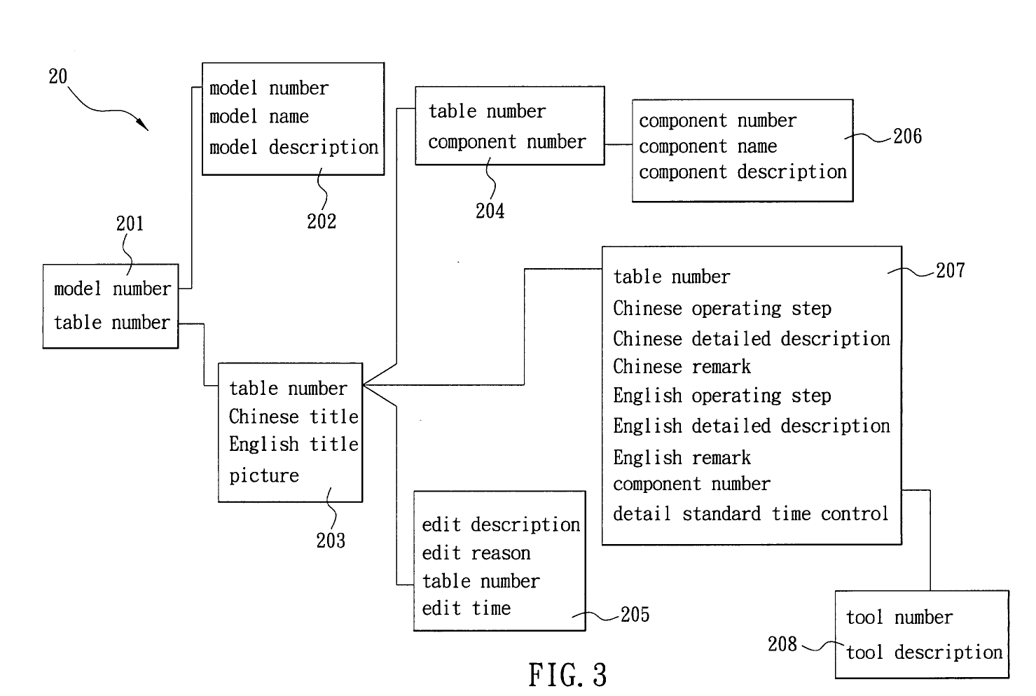

Referring to FIGS. 1 and 3, the system comprises a server 2, at least one assembly line 3 each having a plurality of workstations (e.g., computers) 4, and a network 1 for interconnecting above components. A production management software having an embedded management database 20 is built in the server 2. The management database 20 is constructed based on at least one WI and comprises a plurality of SOPs and multimedia data associated with the SOPs. When the server 2 reads the software a plurality of operation procedures in the management database 20 are sent to the workstations 4 via the network 1. At this time, the workstations 4 can fetch multimedia data contained in the received operation procedure. The fetched multimedia data is then sent to a visual display or audio device for output for prompting and instructing assemblers at the assembly line to finish assigned work within a specified time by complying to the SOPs of the WI.

Referring to FIG. 1 again, an example of allocating an operation procedure on the computer assembly line 3 according to the invention is illustrated. It is assumed that an operation procedure includes (a) case taking, (b) mother board taking, (c) fastening with four screws, . . . (m) label sticking, and (n) packing and delivery in order. Thus, the server 2 can utilize the software to allocate the operation procedure to each workstation 4 for processing. That is, there are 14 workstations 4 and 14 assemblers at the assembly line 3. At this time, the assemblers can obtain the required operation procedure based on output of the workstations 4.

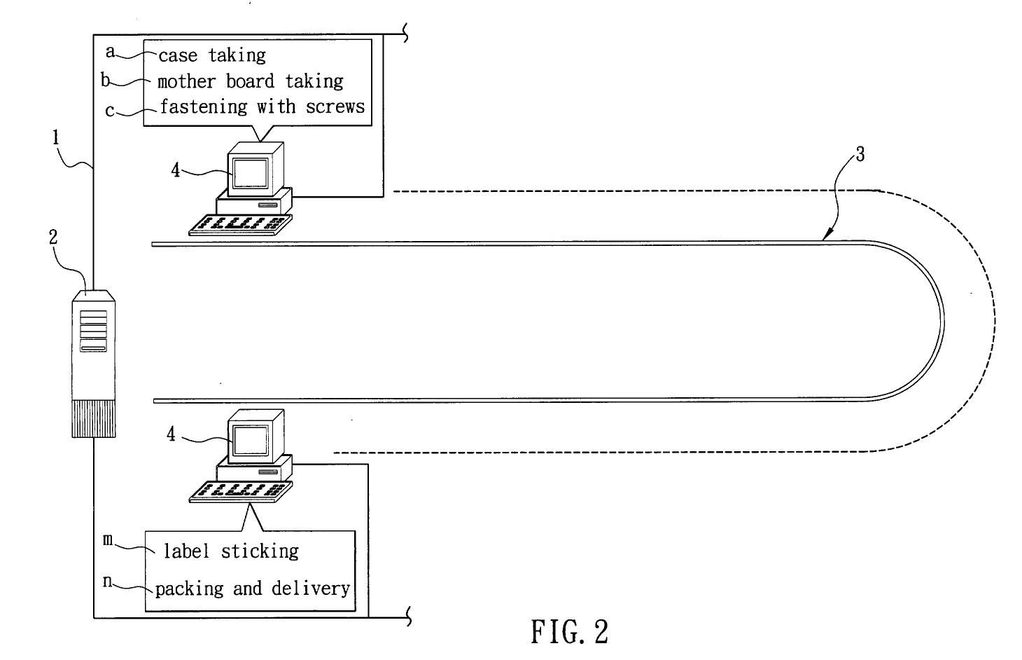

Referring to FIG. 2, following is a description about a case that there are only 11 workstations 4 and assemblers at the assembly line 3. Similarly, the server 2 can utilize the software to allocate all operations (a), (b) and (c) to one of the workstations 4 and both operations (m) and (n) to the other workstation 4. Also, the assemblers can obtain the required operation procedure based on output of the workstations 4. In view of this, the server 2 can allocate different operation procedures to the workstations 4 for output. Hence, different operation procedures can be flexibly allocated to different workstations 4 so as to dynamically accommodate various conditions suddenly occurred at the assembly line 3.

Moreover in a case that one assembler at the assembly line 3 cannot understand the WI he/she still can understand what the required operation procedure is by means of output from the visual display or audio device. Particularly, output from the audio device will audibly inform the assembler for instructing the assembler to follow the operation procedure in operation. This has the benefit of maintaining a good and reliable quality of the products manufactured by the assembly line.

Referring to FIG. 3, there is shown the management database 20 according to a preferred embodiment of the invention. The management database 20 is produced by means of a software package called Access issued by Mircrosoft Corporation. The management database 20 comprises a SOP table 201, a basic model table 202, an operation name table 203, a component table 204, an edit record table 205, a basic component table 206, an operation description table 207, and a basic tool table 208. Each of above tables will now be described in detail below.

The SOP table 201 comprises data fields such as a model field and a table number field. The basic model table 202 comprises data fields such as a model field, a model name field, and a model description field. Further, the model of the basic model table 202 is connected to the same of the SOP table 201.

The operation name table 203 comprises data fields such as a table number field, a Chinese title field, an English title field, and a picture field. Further, the table number of the operation name table 203 is connected to the same of the SOP table 201.

The component table 204 comprises data fields such as a table number field and a component number field. Further, the table number of the component table 204 is connected to the same of the operation name table 203.

The edit record table 205 comprises data fields such as an edit description field, an edit reason field, a table number field, and an edit time field. Further, the table number of the edit record table 205 is connected to the same of the operation name table 203.

The basic component table 206 comprises data fields such as a component number field, a component name field, and a component description field. Further, the component number of the basic component table 206 is connected to the same of the component table 204.

The operation description table 207 comprises data fields such as a table number field, a Chinese operating step field, a Chinese detailed description field, an English operating step field, an English detailed description field, an English remark field, a component number field, and a detail standard time control field. Further, the table number of the operation description table 207 is connected to the same of the operation name table 203.

The basic tool table 208 comprises data fields such as a tool number field and a tool description field. Further, the tool number of the basic tool table 208 is connected to the same of the operation description table 207.

Multimedia data (e.g., text, pictures or voice) compatible to each operation procedure can be written into the fields. Further, multimedia data written into the fields having the same name in the same operation procedure must be the same.

In the embodiment, as referring to FIGS. 1, 3 and 4 the server 2 and the workstations 4 can output an instruction screen 5 on the visual display device. The instruction screen 5 comprises screen fields such as a table number screen field 500, a Chinese title screen field 501, a English title screen field 502, a picture screen field 503, a component number screen field 504, a model screen field 505, an edit description screen field 506, an edit reason screen field 507, an edit time screen field 508, a Chinese operating step screen field 509, a Chinese detailed description screen field 510, a Chinese remark screen field 511, an English operating step screen field 512, an English detailed description screen field 513, an English remark screen field 514, and a tool description screen field 515 wherein multimedia data written into the data fields having the same name is shown on the screen fields.

In the embodiment, there is provided a voice interface in the computer 4 which can be utilized by the computer 4 for reading out the tables or the instruction screen 5 and multimedia data shown or written into the assigned data fields or the screen fields as well as converting the multimedia data into a voice signal. Then a portion (e.g., sound effect) of the voice signal compatible to the multimedia data is sent to the audio device for output. The assigned data field or screen field can be one of the Chinese operating step, the Chinese detailed description, the Chinese remark, the English operating step, the English detailed description, and the English remark fields.

In the embodiment, the computer 4 can sequentially display and play the received operation procedure based on the multimedia data (e.g., working hours) written into the detail standard time control field. In response to the last displayed and played operation procedure, the computer 4 will again sequentially display and play the received first operation procedure. Thus, as the server 2 sends the operation procedures to respective computers 4 the computers 4 can display and play the same in real time. Hence, the assemblers at the assembly line 3 can follow the operation procedure to perform a job.

Also, a total time of performing a plurality of operation procedures by the assembler may not be a summation of time done in all operation procedures. Hence, in the embodiment it is possible of enabling the displayed and played operation procedure on the computer 4 to conform to a real operating time of the assembler by modifying the multimedia data contained in the detail standard time control field. As a result, it is possible of flexibly arranging a standard of working hour at the assembly line 3.

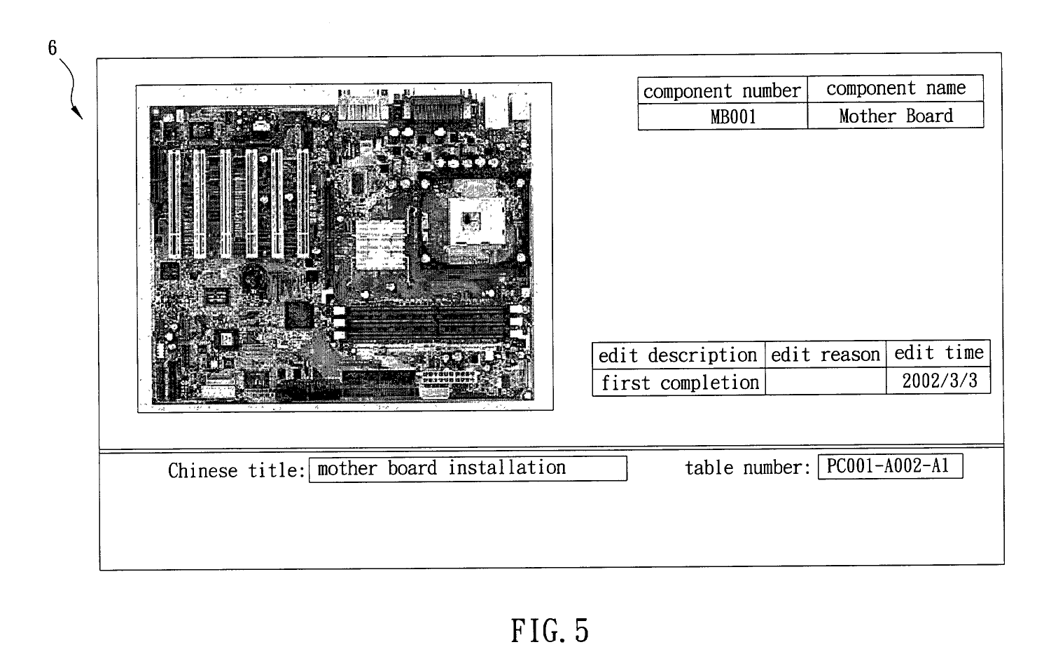

In the embodiment as referring to FIGS. 1, 3 and 5, the server 2 outputs a WI screen 6 on its visual display device based on the tables. A SOP is suitably shown on the WI screen 6 which has a layout the same as a document sized WI. The WI screen 6 comprises the table number, the Chinese title, the edit record, the component number, the component name, and pictures of the tables. Also, the server 2 can completely display all SOPs of a general WI based on the multimedia data written into the tables. Further, a printer connected to the server 2 can print all SOPs. This completes a production of WI. This can eliminate the problem of incapable of effectively producing or modifying WI as experienced by the prior art.

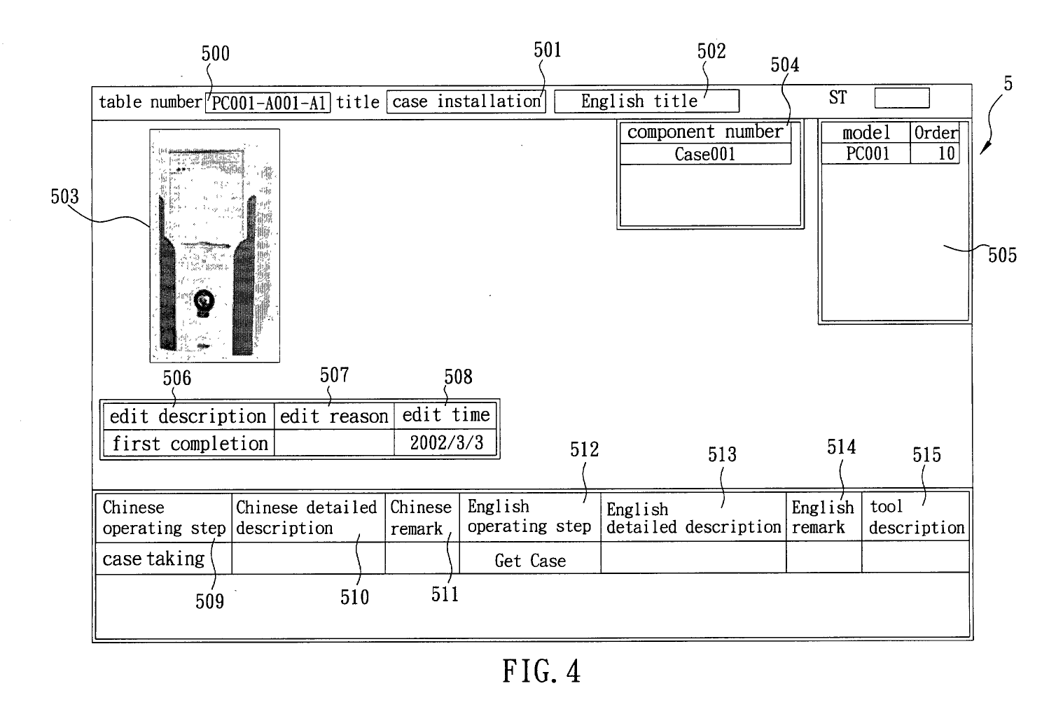

In the embodiment as referring to FIGS. 3 and 4, the server 2 can input multimedia data of each operation procedure including the edit description, the edit reason, the table number, and the edit time fields into the edit record table 205. Alternatively, the server 2 can input multimedia data into the edit description and edit reason screen fields of the instruction screen 5 corresponding to each operation procedure. Next, the input multimedia data is stored in the edit description and edit reason screen fields of the edit record table 205. Further, the stored data in the table number field of the edit record table 205 is fetched from the table number shown on the instruction screen 5. Furthermore, the edit time field of the edit record table 205 is fetched from the current time shown on the server 2. As a result, it can totally solve the problem of ineffective management as experienced by the well known WI.

While the invention has been described by means of specific embodiments, numerous modifications and variations could be made thereto by those skilled in the art without departing from the scope and spirit of the invention set forth in the claims.

What is claimed is:

1. A production operation management system including a server, at least one assembly line each having a plurality of computers at a workstation, and a network for interconnecting the server and the at least one assembly line, the server including a production management software having an embedded management database including a plurality of SOPs (Standard Operation Procedures) and multimedia data associated with the SOPs, in response to a reading of the software by the server, among the server and the computers the system being enabled to perform the steps of:
sending a plurality of operation procedures in the management database to the computers via the network;
instructing the computers to fetch a compatible multimedia data contained in the operation procedure as received by the computers; and
sending the fetched multimedia data to a visual display device or an audio device for output.

2. The system of claim 1, wherein the management database comprises a plurality of data tables each including a plurality of data fields with the multimedia data inputted in the data fields.

3. The system of claim 2, wherein each of the server and the computers is capable of outputting an instruction screen on the visual display device with contents of the instruction screen compatible to the data fields.

4. The system of claim 3, wherein the instruction screen comprises a table number screen field, a Chinese title screen field, an English title screen field, a picture screen field, a component name screen field, a model name screen field, an edit description screen field, an edit reason screen field, an edit time screen field, a Chinese operating step screen field, a Chinese detailed description screen field, a Chinese remark screen field, an English operating step screen field, an English detailed description screen field, an English remark screen field and a tool description screen field with the multimedia data written into the data fields shown on the screen fields.

5. The system of claim 2, wherein each of the computers comprises a voice interface which is capable of being utilized by a CPU (Central Processing Unit) of the computer to read out the multimedia data in the assigned data fields of the instruction screen, convert the multimedia data into a voice signal, and send a sound effect portion of the voice signal compatible to the multimedia data to the audio device for output.

6. The system of claim 2, wherein each of the data tables further comprises a detail standard time control field so that each of the computers is capable of sequentially sending the operation procedure received by the computers to the visual display device or the audio device for output based on the multimedia written into the detail standard time control field.

7. The system of claim 6, wherein in response to the last displayed and played operation procedure, each of the computers is capable of sequentially displaying and playing the received first operation procedure.

8. The system of claim 2, wherein the server is capable of outputting a WI (Work Instruction) screen on the visual display device based on the data tables, and a SOP is arranged to suitably show on the WI screen which has a layout the same as a document sized WI.
